(19) United States
(12) Patent Application Publication
(10) Pub. No.: US 2012/0179870 A1
(43) Pub. Date: Jul. 12, 2012

(54) Data Storage Method with (D,K) Moore Graph-Based Network Storage Structure

(76) Inventors: Jinlin Wang, Beijing (CN); Lingfang Wang, Beijing (CN); Jiali You, Beijing (CN); Haojiang Deng, Beijing (CN)

(21) Appl. No.: 13/376,153

(22) PCT Filed: Nov. 20, 2011
(86) PCT No.: PCT/CN10/00496

§ 371 Date: Mar. 30, 2012

(30) Foreign Application Priority Data
May 20, 2009 (CN) 200910084150.4

(51) Int. Cl. G06F 12/00

(52) U.S. Cl. 711/114; 711/E12.001

(57) ABSTRACT

A data storing method of a (d, k) Moore graph-based network storage structure is provided. The method arranges a number of formula(I) storing nodes in a wide area network (WAN) environment in accordance with a (d, k) Moore graph to form a strongly regular network structure, and utilizes implementation methods of different separate redundant array of independent disks (RAID) techniques of multiple degrees of reliability, thereby enabling data storing supported by network-RAIDs (NRAID) of multiple degrees of reliability in a network environment; said network structure of a strongly regular graph makes an arbitrarily accessed storing node as a controlling node, and uses other d+d(d−1) storing nodes as neighboring nodes of the controlling node, wherein d is the number of one-hop neighboring nodes; and d(d−1) are the number of two-hop neighboring nodes; the controlling node stores metadata of stored data, and sends information of accessing data; the neighboring nodes provide data storing services. The present invention combines the special characteristics of a (d, k) Moore graph with RAID technology, thereby enhancing the reliability of data storing in a network environment.

$$1 + d {\sum }_{i = 0}^{k - 1} {( d - 1 )}^{i} \qquad Formula ( I )$$

### TECHNOLOGY FIELD

The present invention relates to the technology of information network, particularly to a method for storing data in a network storage structure based on (d,k)-Moore graph.

### BACKGROUND OF INVENTION

Today information technology field has already transformed from computing-centered architecture into storage-centered architecture. This is due to the great deal of information produced with the development of Internet. Therefore, the mass information brings about issues such as processing, storing, sharing, etc.

In the process of storing data, RAID, the redundant array of independent disk technology has been proposed to improve data reliability and performance of a single disk. The RAID technology was invented in 1987 by University of California Berkeley.

In brevity, the redundant array of independent disks is the combination of a number of N hard disks, as one virtual single large-capacity hard disk, by a hardware or software Controller. It features that the N hard disks could be concurrently read so that the speed of reading becomes faster, and at the same time it is fault tolerate. Therefore, RAID is often used as primary storage for accessing data rather than data backup.

The conventional redundant array of independent disks technology can be utilized as a single embedded controller, or as an external independent disk array hardware, or as a software RAID controller implanted in an operating system. All of these three utilization means, generally limited to a single host or a local area network, can deal with failure of a single disk, however cannot deal with failures of the overall hardware or software.

The applicant filed a China patent application entitled by “Method for storing data in a Network Storage Structure Based On Peterson Graph” on May 20, 2009, in which the Peterson graph is a fixed structure consisting of 10 nodes, wherein the degree of each of the node is 3, and the distance between any two nodes is no more than 2.

However, the previous investigation only focused on the particular structure, the Peterson graph and the technical solution based on this specific graph, which has great limitation in the range of application.

### SUMMARY OF DISCLOSURE

One purpose of the present invention is to realize storing method of data with high reliability and wide application range. The method is proposed based on (d, k)-Moore graph structure in wide area network, in which the strong structural regular graph consists of storing nodes, and RAID-type disk striping technology is applied between all nodes except the controlling node so as to provide a data storing method in the network storage structure based on (d, k)-Moore graph. The method realizes the application of RAID in wide area network with strong structure, and makes the network advantageously possess both the data reliability and high performance of conventional RAID while avoiding the problem of single point failure.

In the late 1980s, with the gradual maturation of distributed system, a server-free network file system (xFS) was also proposed by university of California Berkley. Therefore, the objective of the present invention is to apply RAID-type disk striping technology among the multi-machine disks of such system, which was named as Network Redundant Array of Independent Disks, capable of providing high reliability data storage in the network environment. With the exception of the limit of the operating environment with respect to NRAID to among the peer workstations, which is similar to the currently popular peer-to-peer system, it can use RAID in network environment in the way primarily identical to xFS. And, the other wide area storage systems are distributed file system in general.

The above NRAID technology utilizes the disk striping techniques in the local area network environment, aiming to accelerate accessing data, which is similar to NRAID0 of present invention, without the reliability guarantee such as data parity. In order to improve the reliability of the file, the distributed file system resorts to the multiple redundant storage of one piece of data, of which the reliability depends on prior storage systems such as the direct attachment storage, the network attachment storage or storage area network, having the general problem of the lower utility of storage.

In order to realize the above mentioned objective, the present invention provides a data storing method in a network storage structure based on (d,k)-Moore graph. The method comprises steps of: arranging

$$1 + d {\sum }_{i = 0}^{k - 1} {( d - 1 )}^{i}$$

storing nodes according to the nodes relationships of (d,k)-Moore graph in a wide area network environment to form a structure of a strongly regular graph, utilizing the disk storage capacity of the multiple network hosts and referring to the implementation way of RAID technology with multiple levels of reliability to realize a data storing method supported by redundancy array of independent disk NRAID with multiple levels of reliability in a network environment. In the structure of the strongly regular graph, any storing node within the network based on (d, k)-Moore graph is regarded as a controlling node for storing information of the metadata, i.e. the detailed information of the storing data nodes, and sending the message of the access data, and the other d+d (d−1) storing nodes are regarded as neighboring nodes for providing data storing service, wherein the d nodes are one-hop nodes, and the d(d−1) nodes are two-hop nodes.

The relationship between the values of (d, k) and the total number of the corresponding network nodes is shown in Table 1, below:

TABLE I

| | k | | | | | | | | |
|---|---|---|---|---|---|---|---|---|---|
| d | 2 | 3 | 4 | 5 | 6 | 7 | 8 | 9 | 10 |
| 3 | 10 | 20 | 38 | 70 | 132 | 196 | 336 | 600 | 1250 |
| 4 | 15 | 41 | 96 | 364 | 740 | 1320 | 3243 | 7575 | 17703 |
| 5 | 24 | 72 | 210 | 624 | 2772 | 5516 | 17030 | 53352 | 164720 |
| 6 | 32 | 110 | 390 | 1404 | 7917 | 19282 | 75157 | 295025 | 1212117 |
| 7 | 50 | 168 | 672 | 2756 | 11988 | 52768 | 233700 | 1124990 | 5311572 |
| 8 | 57 | 253 | 1100 | 5060 | 39672 | 130017 | 714010 | 4039704 | 17823532 |
| 9 | 74 | 585 | 1550 | 8200 | 75893 | 270192 | 1485498 | 10423212 | 31466244 |
| 10 | 91 | 650 | 2223 | 13140 | 134690 | 561957 | 4019736 | 17304400 | 104058822 |
| 11 | 104 | 715 | 3200 | 18700 | 156864 | 971028 | 5941864 | 62932488 | 250108668 |
| 12 | 133 | 786 | 4680 | 29470 | 359772 | 1900464 | 10423212 | 10405822 | 600105100 |
| 13 | 162 | 851 | 6560 | 39576 | 531440 | 2901404 | 17823532 | 180002472 | 1050104118 |
| 14 | 183 | 916 | 8200 | 56790 | 816294 | 6200460 | 41894424 | 450103771 | 2050103984 |
| 15 | 186 | 1215 | 1712 | 7298 | 1417248 | 8079298 | 90001236 | 900207542 | 4149702144 |
| 16 | 198 | 1600 | 1640 | 132496 | 1771560 | 14882658 | 104518518 | 1400103920 | 7394669856 |

The storing type of each of the storing nodes includes direct attachment storage, network attachment storage or storage area network. The direct attachment storage takes the forms of single disk or RAID.

The network redundant array of independent disks technology (NRAID) may arbitrarily select any type from the six types of network redundant array of independent disks, i.e., from NRAID0 to NRAID5. The implementing method of each level network redundant array of independent disks is described as below:

1) The data storing method uses NRAID0, which is a group of stripes without error controlling, including more than two neighboring nodes in addition to the controlling node, and data being divided into blocks and stored into different storing nodes and being able to be accessed simultaneously.

The implementing method of NRAID0 distributes different data onto different storing nodes so that the throughput rate of the data is greatly improved and the loads on storing nodes are well balanced. In the event that the required data being stored on different storing nodes, the method can obtain the best performance. The method does not need to calculate parity and so it is easy to realize. The disadvantageous of the method is that it does not perform data error controlling, so that if data error occurs in one storing node, the whole data becomes useless even if the rest data stored on other storing nodes are correct. Therefore, the method is not suitable to be used in situation with higher data stability requirement. Furthermore, NRAID0 can improve data transmission rate in situations such as the file is distributed over two storing nodes capable of being accessed at the same time, so that the time needed to read the same file is reduced to half time. Among all reliability levels, NRAID0 is the fastest but lacks of redundancy. Therefore, if one storing node is (physically) destroyed, all data will be useless.

2) The data storing method uses NRAID1 in a mirror structure, and the controlling node simultaneously performs reading and writing on the two storing nodes, wherein one of the two nodes is primary storing node, and the other is mirror storing node.

The implementing method of NRAID1 is a minor structure, in which when an error occurs on one storing node the mirror storing node will function as primary node, so as to improve fault-tolerance, i.e. when the primary storing node crashes, the mirror storing node can take the responsibility of the primary storing node. In this embodiment, the mirror storing node acts as a backup storing node for primary storing node. Furthermore, it is easy to design and implement, where it can only read one piece of data each time the storing node is read, which means that the data transmission rate equals to the accessing rate of independent read/write operation. Since NRAID1 has thorough verification, which has a significant influence on the processing capability of the system, the functions of RAID1 are usually realized by software, which in turn tradeoffs the server's efficiency when the server is overloaded. Therefore, NRAID1 is suitable in situations with ultra-reliability requirement such as statistical data processing. Furthermore, NRAID1 technique supports “hot-swap”, i.e., replacing the failed storing node without power-off, followed by recovering data just from the mirror storing node. However, the space utility of storing nodes in NRAID1 is only 50%, which is the least of all NRAID levels.

3) The data storing method uses NRAID2 in data striping structure with hamming code, in which the data are divided into stripes and distributed among different storing nodes, the unit of the striped data is a bit or a byte. A data encoding technology is used to provide error detection and recovery, where multiple nodes are needed to store the detection and recovery information.

Due to the feature of hamming-code, when data error occurs, it is possible to correct it, so the output is guaranteed to be correct. Since the data transmission rate of NRAID2 is rather high, if an ideal speed is required, it is better to raise the speed of nodes storing the verification ECC codes. Moreover, the rate of data output of controlling node is equal to the slowest one of the group of storing nodes.

4) The data storing method uses NRAID3, which is a parallel transmission structure with even-odd parity.

Each controlling node stores the address information of its n neighboring nodes and the information about the interleaving rule of the stored data, wherein 3≦n≦d+^{d (d-1)}, and n−₁ neighboring nodes being used for storing the data, and the nth neighboring node being used as a special storing node for the redundant information of even-odd parity information,.

After the controlling node completes the operation of reading or writing metadata, a read terminal reads data and parity information from the n neighboring nodes in parallel, and then combines the data read out and makes verification.

This kind of verification codes is only able to detect error, but unable to correct error, and handles one stripe each time of accessing the data, so it can increase the speed of reading and writing. The verification codes are generated when writing data and stored on another node. Upon requirement, three storing nodes directly adjacent to the controlling node are used, thus both reading speed and writing speed are fairly high because of fewer verification bits, which in turn reduces the time that the computing procedure spends.

NRAID3 uses a single node to store the parity information. If one of the storing nodes fails, the node storing the parity information and the other data storing nodes can reconstruct the original data. And, if the node storing the parity information fails, it does not affect data availability. NRAID3 can offer high transmission rate for a large volume of continuous data, whereas for random data, the node storing the parity information becomes the bottleneck of writing. Although using a single verification node to protect data has a lower security than that of minor node, the storage utility ratio of space is greatly improved, and reaches to (n−1)/n.

5) The data storing method uses NRAID4, which is an independent storing nodes structure with even-odd parity code.

Each controlling node stores the address information of its n neighboring nodes and the information about interleaving rule of the stored data, wherein 3≦n≦d+^{d(d-1)}, the n−1 neighboring nodes are used to store data, and the nth neighboring node acts as the special storing node for the redundant information of the even-odd parity information.

After the controlling node completes the operation of reading or writing metadata, the data block is accessed node by node, and one storing node is accessed every time. Finally, a read terminal reads data and parity information from the n neighboring nodes, combines the data and makes verification. Similarly, this verification code is only able to detect error, but unable to correct error.

The reading terminal can be either the controlling node or a reading terminal of client.

6) The data storing method uses NRAID5, which is a structure of independent storing nodes with distributed even-odd parity, and the parity bit of data segment is interleaved into the storing nodes, wherein the even-odd parity codes are stored on all storing nodes and distributed over different nodes to guarantee the security of the data with its parity bit.

In case of any one of the storing nodes crashes, it is always possible to reconstruct the crashed data from the remaining data and parity information stored on other storing nodes. NRAID5 provides the data security also by using the data parity bits. However, it stores data parity bits on all storing nodes rather than on a single storing node. NRAID5 advantageously provides extra redundancy that it is still available even though one storing node is offline, thus obtains a high space utilization ratio, ((n−1)/n), and a fast accessing speed (n−1 times of that of one disk). However, if one storing node crashes down, the operation efficiency will reduce tremendously.

Compared with other current structures and methods, the present invention has the following advantageous: it guarantees the connection of data paths and confines the parameters such as time delay to acceptable scope by combining the special properties of (d,k)-Moore graph with RAID technology and relying on the strong structural feature of (d,k)-Moore graph; and each node of (d,k)-Moore graph can act as a controlling node, totaling 1+d+^{d(d-1)} nodes, thus eliminating the single failure point of the conventional RAID controller. According to the present invention, each of the individual nodes has the same structure, which in turn results in the nodes' similar performance. Therefore, the same algorithms are performed on any individual node to implement NRAID so as to improve the reliability of data stored in network environment, which can be used in wide area data storage.

Compared with Peterson graph, the advantages of the present invention include:

The previous technical solution based on Peterson graph is only applied to the situation where the node degree is 3 and the maximal diameter is 2. The proposed solution that utilizes (d,k)-Moore according to the present invention can suit to all situations that both d and k are equal to or greater than 2, which expands the range of application.

In the case of dealing with nodes more than 10, the multiple Peterson graph must be employed to cover all the nodes, and at the same time the problem of interconnection among Peterson graphs needs to be resolved by other ways. Contrastively, the (d,k)-Moore graph whose number of nodes mostly approximates the number of real nodes is employed to create the network, so that the mechanism of (d,k)-Moore graph may deal with the situation with many nodes.

If the number of real nodes increases, the change of d or k in (d,k)-Moore graph may evolve into new (d,k)-Moore graphs, but the processing mechanism does not change, so the present method has good extendibility.

Furthermore, the present invention expands the technology of redundant array of independent disk to network environment. Firstly, it resolves the problem that the single position of the conventional redundant array of independent disk suffers from data unavailability due to power failure. Secondly, the strong structural nature of (d,k)-Moore graph guarantees the connection of data paths among storing nodes and confines the parameter such as time delay to an acceptable scope. And, thirdly, each node of (d,k)-Moore graph can act as a controlling node, totaling 1+d+^{d(d-1)} controlling nodes, which eliminates the problem of single failure point of the conventional RAID controller.

### BRIEF DESCRIPTION OF THE DRAWINGS

FIG. 1 is the schematic of the storage network structure based on (3,2)-Moore graph of the present invention;

FIG. 2 is the schematic showing the node numbering of (3,2)-Moore graph;

FIG. 3 is the schematic of the storage network structure of Beijing, based on (3,2)-Moore graph;

FIG. 4 is the schematic showing the node numbering of the storage network structure based on (2,3)-Moore graph of the present invention;

FIG. 5 is the schematic showing the node numbering of the storage network structure based on (4,2)-Moore graph.

### DETAILED DESCRIPTION OF THE INVENTION

Hereafter, the present invention will be described in details referring to the figures and examples.

With reference to the attached figures, the realization of network redundant array of independent disks based on (d,k)-Moore graph such as (3,2)-Moore graph, (2,3)-Moore graph, or (4,2)-Moore graph, etc., will be further explained and well understood.

The purpose of the present invention is to provide an implementing method of network redundant array of independent disks based on (d,k)-Moore graph which consists of

$$1 + d {\sum }_{i = 0}^{k - 1} {( d - 1 )}^{i}$$

storing nodes as shown in FIG. 1, wherein the network redundant array of independent disks is preferably divided into 6 levels, i.e. from NRAID0 to NRAID5. With respect to each level of network redundant array of independent disks, the present method provides a corresponding method of realizing the network redundant array of independent disks, wherein each storing node has its own storage which may be selected from DAS (Direct Attachment Storage, a single disk or RAID), NAS (Network Attachment Storage) or SAN (Storage Area Network).

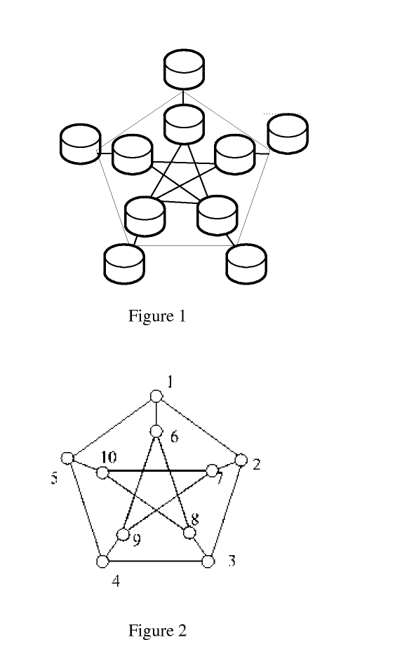

In order to realize the above purpose of the present invention, the nodes of storing network based on (d,k)-Moore graph such as (3,2)-Moore graph is numbered as shown in FIG. 2, where the neighboring nodes of each node include d one-hop neighboring nodes and d(d−1) two-hop neighboring nodes and these neighboring nodes are unchangeably set through test or manual arrangement, which is similar to the initialization procedure of the conventional redundant array of independent disks. Each node acts a controlling node of its neighboring nodes, wherein the controlling node is responsible for sending the information of accessing the data and storing the metadata of data such as the location information of stripes after data are striped, and the neighboring nodes is responsible for data storing.

### EXAMPLE

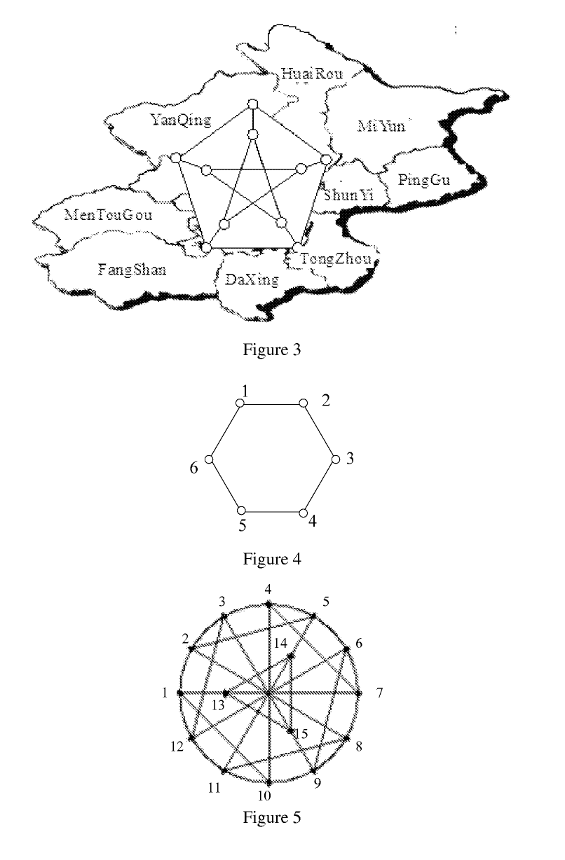

In the following, with respect to a specific application scenario, the realization methods of the network redundant array of independent disks based on (3,2)-Moore graph, (2,3)-Moore and (4,2)-Moore graphs are demonstrated. As shown in FIG. 3, one application scenario of the present invention assumes that a company which provides storing service in a city such as Beijing, deploys 10 storing nodes, these storing nodes being interconnected by links with a bandwidth larger than 500 Mbps. These 10 nodes are configured in (3,2)-Moore graph and are numbered as shown in FIG. 2.The degree of each node and the distance between any two nodes of (3,2)-Moore graph are shown in tables 2 and 3 respectively.

TABLE 2
node degree of each node

| No. of nodes | Node Degree |
|---|---|
| 1 | 3 |
| 2 | 3 |
| 3 | 3 |
| 4 | 3 |
| 5 | 3 |
| 6 | 3 |
| 7 | 3 |
| 8 | 3 |
| 9 | 3 |
| 10 | 3 |

TABLE 3
distance between any two nodes

| | 1 | 2 | 3 | 4 | 5 | 6 | 7 | 8 | 9 | 10 |
|---|---|---|---|---|---|---|---|---|---|---|
| 1 | 0 | 1 | 2 | 2 | 1 | 1 | 2 | 2 | 2 | 2 |
| 2 | 1 | 0 | 1 | 2 | 2 | 2 | 1 | 2 | 2 | 2 |
| 3 | 2 | 1 | 0 | 2 | 2 | 2 | 2 | 1 | 2 | 2 |
| 4 | 2 | 2 | 1 | 0 | 1 | 2 | 2 | 2 | 1 | 2 |
| 5 | 1 | 2 | 2 | 1 | 0 | 2 | 2 | 2 | 2 | 1 |
| 6 | 1 | 2 | 2 | 2 | 2 | 0 | 2 | 1 | 1 | 2 |
| 7 | 2 | 1 | 2 | 2 | 2 | 2 | 0 | 2 | 1 | 1 |
| 8 | 2 | 2 | 1 | 2 | 2 | 1 | 2 | 0 | 2 | 1 |
| 9 | 2 | 2 | 2 | 1 | 2 | 1 | 1 | 2 | 0 | 2 |
| 10 | 2 | 2 | 2 | 2 | 1 | 2 | 1 | 1 | 2 | 0 |

Hereafter, as examples, where three direct neighboring nodes of one particular node are used to store data and NRAID0 and NRAID3 are used, the realization methods of network redundant array of independent disks will be illustrated in details. For those skilled in the art, it is easy to understand that the cases of 4 to 9 neighboring nodes can be analogously deduced.

(1) NRAID0

Each node stores the address information of its 3 direct neighboring nodes. For example, node 1 stores the address information of nodes 5, 6 and 2. According to the aforementioned realization method of NRAID0, node 1, acting as controlling node, stores the information of striping rule of data, and the data is stored on node 5, 6 and 2 in the form of stripes. The metadata is read by node 1, then the data are read out from nodes 5, 6 and 2 in parallel. Furthermore, the data read out are combined by a reading terminal which can be node 1 or other reading client.

(2) NRAID3

Each node stores the address information of its 3 direct neighboring nodes. For example, node 1 stores the address information of nodes 5, 6 and 2. According to the aforementioned realization method of NRAID3, node 1, acting as the controlling node, stores information of interleaving rule of data, the data is stored on nodes 5 and 6, and node 2 acts as a special storing node for redundant odd-even parity verification information. The metadata and verification information is read by node 1, and the data and the verification information are read out from nodes 5, 6 and 2 in parallel. The data are combined and verified by a reading terminal which can be node 1 or other reading client.

Although the above embodiments take NRAID0 and NRAID3 as examples to illustrate the implementation of network redundant array of independent disks based on (3,2)-Moore graph where 3 direct neighboring nodes of one node are chosen to store data or verification information, they are just for the purpose of illustration, for person skilled in the art, it is obvious to implement the other 4 levels of the network redundant array of independent disks according to the description of the present invention.

As for the cases of (2,3)-Moore and (4,2)-Moore graphs, persons skilled in the art can easily implement the present method with reference to that of (3,2)-Moore graph as mentioned above.

Further, one should note that the above examples are only for the purpose of illustration of the technical solution of the present invention rather than bringing any limit to the present invention. While the present invention is described in detail with reference to the above examples, those skilled in the art should understand that any modification or replacement made under the spirits or teachings of the present invention should fall into the scope claimed by the following claims.

1. A data storing method in a network storage structure based on (d,k)-Moore graph, comprising steps of:
arranging
$$1 + d {\sum }_{i = 0}^{k - 1} {( d - 1 )}^{i}$$
storing nodes according to nodes relationships of (d,k)-Moore graph in a wide area network environment to form a structure of a strongly regular graph, and
utilizing the disk storage capacity of the multiple network hosts and referring to the implementation way of RAID technology with multiple levels of reliability to realize a data storing method supported by redundancy array of independent disk NRAID with multiple levels of reliability in a network environment,
wherein in the structure of the strongly regular graph, any storing node within the network based on (d, k)-Moore graph is regarded as a controlling node for storing information of the metadata, i.e. the detailed information of the storing data nodes, and sending the message of the accessed data, and the other d+d(d−1) storing nodes are regarded as neighboring nodes for providing data storing service, wherein the d nodes are one-hop nodes, and the d(d−1) nodes are two-hop nodes.

2. The method according to claim 1, wherein the storage type of each of the storing nodes includes direct attachment storage, network attachment storage or storage area network.

3. The method according to claim 1, wherein said direct attachment storage takes the form of a single disk or RAID.

4. The method according to claim 1, wherein said data storing method uses NRAID0, which is a group of stripes without error controlling, including more than two neighboring nodes in addition to said controlling node, and data being divided into blocks and stored into different storing nodes and being able to be accessed simultaneously.

5. The method according to claim 1, wherein said data storing method uses NRAID 1 in a minor structure, and said controlling node simultaneously performs reading and writing on said two storing nodes, wherein one of said two nodes is primary storing node, and the other is minor storing node.

6. The method according to claim 1, wherein said data storing method uses NRAID2 in data striping structure with hamming code, in which said data are divided into stripes and distributed on different storing nodes, the unit of said striped data being a bit or a byte, wherein a data encoding technology is used to provide error detection and recovery, and wherein multiple nodes are needed to store said detection and recovery information.

7. The method according to claim 1, wherein said data storing method uses NRAID3, which is a parallel transmission structure with even-odd parity, each controlling node stores the address information of its n neighboring nodes and the information about the interleaving rule of the stored data, wherein 3≦n≦d+d(d−1), and said n−1 neighboring nodes being used for storing the data, and the nth neighboring node being used as a special storing node for the redundant information of the even-odd parity information,
after said controlling node completes the operation of reading or writing metadata, a reading terminal reads data and parity information from said n neighboring nodes in parallel, and then combines the said data read out and makes verification.

8. The method according to claim 1, wherein said data storing method uses NRAID4, which is an independent storing nodes structure with even-odd parity code,
each controlling node stores the address information of its n neighboring nodes and the information about interleaving rule of the stored data, wherein 3≦n≦d+d (d−1), said n−1 neighboring nodes being used for storing said data, and said nth neighboring node being used as a special storing node for the redundant information of said even-odd parity information,
after said controlling node completes the operation of reading or writing metadata, said data block is accessed node by node and one storing node is accessed every time,
finally, a reading terminal reads data and parity information from said n neighboring nodes, and combines the said data read out and makes verification thereof.

9. The method according to claim 7, wherein said reading terminal is said controlling node.

10. The method according to claim 1, wherein said data storing method uses NRAID5, which is a structure of independent storing nodes with distributed even-odd parity, said parity bit of data segment being interleaved on said storing nodes, wherein said even-odd parity codes are stored on all storing nodes and distributed over different storing nodes to guarantee the security of the data with its parity bit.
